(19) United States
(12) Patent Application Publication
(10) Pub. No.: US 2006/0176648 A1
(43) Pub. Date: Aug. 10, 2006

(54) Disk array device

(75) Inventors: Tetsuya Inoue, Odawara (JP); Hiroshi Suzuki, Sagamihara (JP); Hiromi Matsushige, Hiratsuka (JP); Masato Ogawa, Chigasaki (JP); Tomokazu Yokoyama, Fujisawa (JP); Masateru Kurokawa, Chigasaki (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 11/085,052

(22) Filed: Mar. 22, 2005

(30) Foreign Application Priority Data
Feb. 8, 2005 (JP) 2005-031253

(51) Int. Cl. H02B 1/00

(52) U.S. Cl. 361/600

(57) ABSTRACT

In a disk array device on which plural power supply units and plural HDD modules operated by the power supplied from power supplies of the power supply units subjected to temperature control by the airflow generated by cooling fans are connected in parallel and mounted via a relay substrate, the power supply unit has a power control unit for supplying power to the cooling fan in a normal operation from the power supply in the self power supply unit having the relevant cooling fan, and, when failure occurs in the power supply, supplying power to the cooling fan in the self power supply unit having the relevant power supply from another power supply in another power supply unit different from the relevant self power supply unit.

### CROSS-REFERENCE TO RELATED APPLICATION

The present application claims priority from Japanese Patent Application JP 2005-31253 filed on Feb. 8, 2005, the content of which is hereby incorporated by reference into this application.

### TECHNICAL FIELD OF THE INVENTION

The present invention relates to a disk array device having power supplies, and in particular, relates to a technique which is effective when applied to temperature control techniques in a disk array device in which a redundant configuration, addition/reduction, and replacement of the power supply part can be implemented.

### BACKGROUND OF THE INVENTION

It is generally known that, in an information processing device, power supply part of the device is caused to have a redundant structure in order to improve reliability of the operation thereof. For example, a disk array device which is used as an external storage device of an information processing system has a configuration provided with a plurality of HDDs (Hard Disk Drives) constituting a disk array, a controller for controlling the disk array, and power supplies for supplying power to the disk array device; wherein, in order to ensure system expandability and reliability of operation, addition/reduction and replacement of the HDDs, and a redundant configuration, addition/reduction, and replacement of the power supplies can be implemented.

For example, in a disk array device described in Patent Document 1 (Japanese Patent Application Laid-Open (kokai) No. H11-184570), a power supply and a fan for cooling interior of the device are made into a module, and used as one power supply unit. The power supply unit has a capacity that the entire device can be driven by one unit, and a plurality of the power supply units are mounted, so as to form a redundant configuration of the power supplies.

Moreover, according to the structure, power feeding to the fan which is in the power supply unit is performed from the power supply in another power supply unit connected thereto via the power supply in the relevant power supply unit and a relay substrate, therefore, even when failure occurs in the power supply which is in the relevant power supply unit, the operation of the fan is not stopped.

The above described power supply unit includes the power supply and the fan as one module, and, in order to avoid erroneous connection to the relay substrate, the power supply and the fan have separate connectors mounted thereon, and are connected to the relay substrate.

### SUMMARY OF THE INVENTION

However, in the disk array device of the above described Patent Document 1, the power supply and the fan are made into one module, and a plurality of the modules are mounted, thereby implementing a redundant configuration of the power supplies and a redundant configuration of power feeding to the fans; nevertheless, the redundant circuit for feeding power to the fan is connected only by an OR circuit, and the balance of the power is not taken into consideration. Accordingly, power feeding to the fans may be deviated in certain power supplies in the redundant configuration due to variation in the power supplies, etc. If deviation of power is caused, shortening of the life of the power supplies and deviation of temperature in the device due to heat generation of the power supplies may be caused.

Moreover, according to the technique of above described Patent Document 1, it is configured such that one power supply can supply the power that is consumed by the entire device, therefore, the size of the power supply is increased in the case employing a large device, and maintenance work or the like of the device is made harder. Besides, the area influenced upon power supply failure is enlarged.

Moreover, according to the technique of above described Patent Document 1, individual connectors are used in the connectors for the power supplies and the connectors for feeding power to the fans; therefore, the number of the connectors inevitably increases.

Thereat, an object of the present invention is, in order to solve problems such as those described above and improve reliability of device operation, to provide a disk array device having a structure in which power feeding to the cooling fans for maintaining a stable device temperature is not affected by failure in the power supply system.

Typical elements of the present invention disclosed in the present application are simply summarized as the following.

The present invention is applied to a disk array device having a plurality of power supply units each of which has a power supply and a cooling fan; a plurality of HDD modules each of which is operated by the power supplied from the power supply, and subjected to temperature control by airflow generated by the cooling fan; and a relay substrate on which the plurality of power supply units and the plurality of HDD modules are connected in parallel and mounted; and has the following characteristics.

(1) Each of the plurality of power supply units has a power control unit for supplying power to the cooling fan in a normal operation from the power supply which is in self power supply unit having the relevant cooling fan, and, when failure occurs in the power supply, supplying power to the cooling fan which is in the self power supply unit having the relevant power supply from another power supply which is in the power supply unit different from the relevant self power supply unit. Accordingly, power is uniformly consumed among power supplies in a normal operation, and shortening of the life of the power supplies and deviation in heat generation due to deviation in the power output from the power supplies can be reduced.

(2) The plurality of power supply units and the plurality of HDD modules are divided into groups, a power supply boundary for each of the groups is provided in the relay substrate, and the plurality of power supply units and the plurality of HDD modules in each of the groups are connected in parallel within an area divided by the power supply boundary of the relay substrate. Accordingly, the power that has to be supported by one power supply can be reduced, therefore, the power supplies can be downsized, maintenance work is facilitated, and the area influenced upon power supply failure can be reduced.

(3) Each of the plurality of power supply units is connected to the relay substrate via a connector, and terminals connected to the power supply unit and the cooling fan of one of the power supply units are disposed in each connector. Accordingly, the power supply units can be directly connected to the relay substrate, moreover, the power supply and the cooling fan can be controlled by one connector. The connector has a terminal disposition with which an insertion position and an insertion direction can be recognized. Therefore, erroneous insertion can be prevented.

(4) The power control unit has first and second current limiting devices and first to third backflow prevention devices, the power supply which is in the self power supply unit is connected to the cooling fan in the self power supply unit through the first current limiting device and the first backflow prevention device which is forwardly connected, and the power supply which is in the another power supply unit is connected to the cooling fan in the self power supply unit through the second current limiting device and the second and the third backflow prevention devices which are forwardly connected. Accordingly, in a normal operation, the cooling fan is driven by the power supplied from the power supply in the self power supply unit, and, when failure occurs in the power supply, the cooling fan can be driven by supplying power from the power supply which is in another power supply unit.

(5) Each of the plurality of power supply units and the plurality of HDD modules comprises a plurality of sections, and the power supply boundary is determined such that number of the sections of the power supply units and number of the sections of the HDD modules agree. Accordingly, cooling of the HDD modules can be uniformly performed, and the life of the HDD modules can be also uniformed.

(6) Each of the plurality of power supply units and the plurality of HDD modules has a RAID configuration in which a plurality of independent interfaces are connected to a plurality of the HDD modules, and the power supply boundary is determined such that one of the power supply units can control two of the RAID configurations. Accordingly, the one power supply unit controls the two sections of the HDD modules, thereby controlling the two RAID configurations.

The effects obtained by typical elements of the present invention disclosed in the present application are simply described as the following.

According to the present invention, reliability of device operation can be improved by employing a structure in which power feeding to the cooling fans for maintaining a stable device temperature is not affected by failure of the power supply system.

### BRIEF DESCRIPTIONS OF THE DRAWINGS

FIGS. 1A, 1B, and 1C show the overall configuration of a disk array device of an embodiment of the present invention, wherein FIG. 1A is a drawing viewed from the front, FIG. 1B is a drawing viewed from a side, and FIG. 1C is a drawing viewed from the rear;

FIG. 2 is a drawing showing a structural disposition pattern of an HDD box in a disk array device which is an embodiment of the present invention;

FIG. 3 is a drawing showing an electrical connection pattern of the HDD box in a disk array device which is an embodiment of the present invention; and

FIG. 4 is a drawing showing an electrical connection pattern (an example in which a plurality of cooling fans are connected in parallel) of another HDD box in a disk array device which is an embodiment of the present invention.

### DESCRIPTIONS OF THE PREFERRED EMBODIMENTS

Hereinafter, embodiments of the present invention will be described in detail with reference to the accompanying drawings. Note that components having the same function are donated by the same reference symbols throughout the drawings for describing the embodiment, and the repetitive description thereof will be omitted.

<Overall Configuration of Disk Array Device>

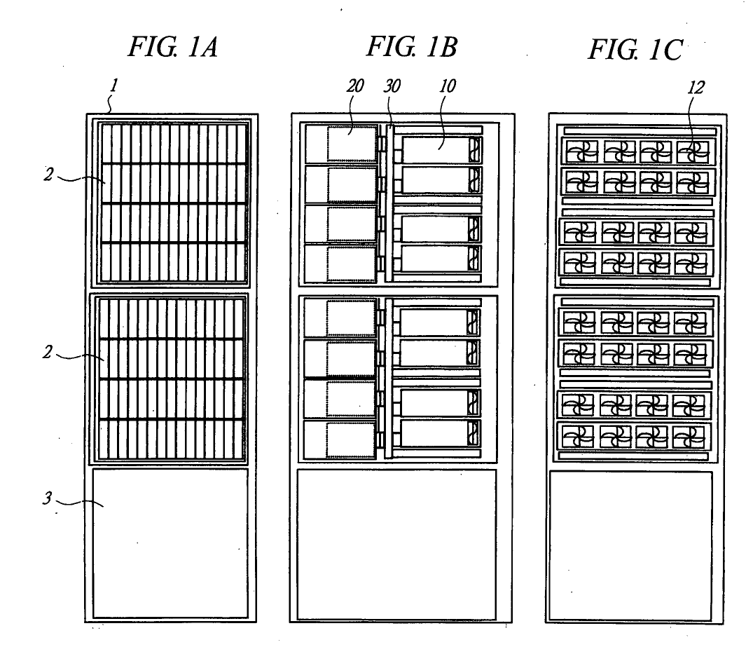

An example of the overall configuration of a disk array device which is an embodiment of the present invention will be described with reference to FIG. 1. FIGS. 1A, 1B, and 1C show the overall configuration of the disk array device of the present embodiment, wherein FIG. 1A is a drawing viewed from the front, FIG. 1B is a drawing viewed from a side, and FIG. 1C is a drawing viewed from the rear.

The disk array device of the present embodiment is, for example, as shown in FIGS. 1A, 1B, and 1C, a rack-mount type wherein various function boxes constituting the disk array device are accommodated in a chassis frame 1. The function boxes include HDD boxes 2 accommodating a plurality of HDD modules, a logic control box 3 accommodating a logic control unit and an AC power supply unit, etc. The chassis frame 1 accommodates a first HDD box 2 in an upper section, a second HDD box 2 in a middle section, and the logic control box 3 in a lower section.

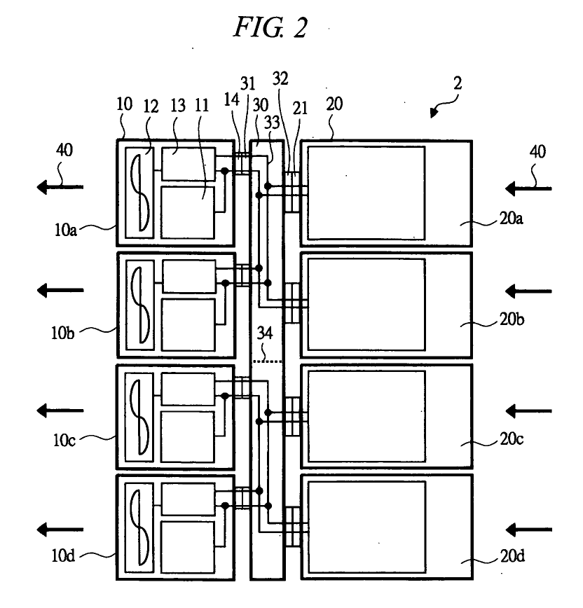

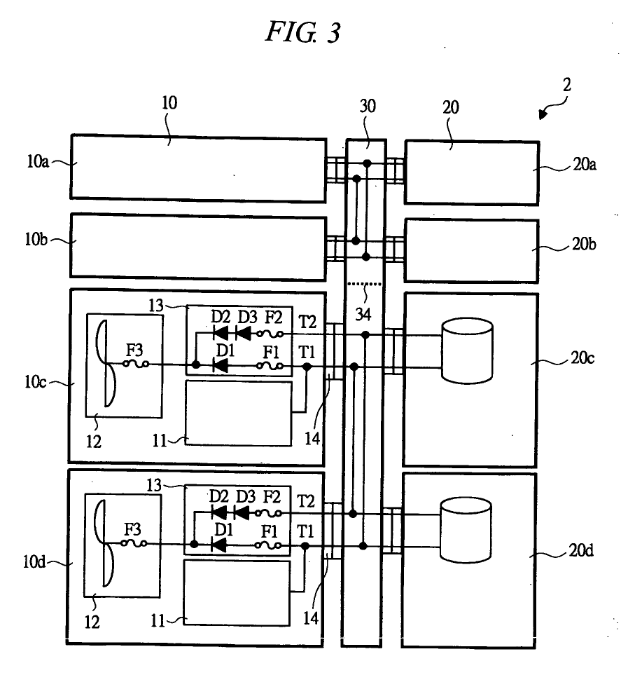

The HDD box 2 accommodates a plurality of power supply units 10, a plurality of HDD modules 20, a relay substrate 30, etc., and the details will be described later by use of FIG. 2 and FIG. 3. For example, in the example of FIG. 1, one HDD box 2 comprises four sections, and, in each of the first to fourth sections, one power supply unit 10 and 15 HDD modules 20 are provided.

Although unillustrated, the logic control unit and the AC power supply unit are accommodated in the logic control box 3. Provided in the logic control unit are, for example, a disk adapter for controlling write and read of data that are performed on HDDs of the HDD modules 20, a channel adapter for receiving data input and output requests from outside, a shared memory storing control information which is communicated by the channel adapter and the disk adapter, a cache memory for temporarily storing data which is communicated between the channel adapter and the disk adapter, controller which manages overall control, and a service processor for managing the disk array device. The AC power supply unit is an AC power supply for supplying AC voltage, which is supplied from outside, to the HDD boxes 2 and the logic control unit in the disk array device.

<Configuration of HDD Box>

An example of the configuration of the HDD box will be described by use of FIG. 2 and FIG. 3. FIG. 2 and FIG. 3 show the configuration of the HDD box; and FIG. 2 is a drawing showing a structural disposition pattern, and FIG. 3 shows an electrical connection pattern.

The HDD box 2 of the present embodiment comprises, for example, as shown in FIG. 2, the plurality of power supply units 10 (10a, 10b, 10c, and 10d), the plurality of HDD modules 20 (20a, 20b, 20c, and 20d), and the relay substrate 30; and has a configuration in which interior of the HDD box 2 is subjected to temperature control by an airflow 40 directed from the front side to the rear side.

The power supply unit 10 is provided with a power supply 11; a cooling fan 12; and a power control unit 13 which supplies power to the cooling fan 12 in a normal operation from the power supply 11 in the self power supply unit 10 having the relevant cooling fan 12, and, when failure occurs in the power supply 11, supplies power to the cooling fan 12 in the self power supply unit 10 having the relevant power supply 11 from another power supply 11 in a power supply unit 10 which is different from the relevant self power supply unit. The power supply 11 and the power control unit 13 are electrically connected, and the cooling fan 12 and the power supply control unit 13 are electrically connected.

A connector 14 that is electrically connected to the power supply 11 and the power control unit 13 is provided on the power supply unit 10, and a connector 31 which is the receiver side thereof is provided on the relay substrate 30. The power supply unit 10 can be mounted on the relay substrate 30 via the connector 14. In one connector 14, terminals connected to the power supply 11 and the cooling fan 12 of one power supply unit 10 are disposed. The connector 14 has a structure with which the insertion position and the insertion direction can be recognized by taking, for example, the position of the connector 14 and the terminal disposition into consideration, such that the power supply unit 10 cannot be inserted at a wrong position and into a wrong direction.

The power control unit 13 in the power supply unit 10 has, although the details will be described later by use of FIG. 3, first and second fuses F1 and F2 serving as current limiting devices, and first to third diodes D1 to D3 serving as backflow prevention devices. The power supply 11 in the self power supply unit 10 is connected to the cooling fan 12 in the self power supply unit 10 through the first fuse F1 and the first diode D1 which is forwardly connected, and the power supply 11 in another power supply unit 10 is connected to the cooling fan 12 in the self power supply unit 10 through the second fuse F2 and the second and the third diodes D2 and D3 which are forwardly connected.

The HDD module 20 is operated by the power supplied from the power supply 11 in the power supply unit 10, and is subjected to temperature control by the airflow 40 caused by the cooling fan 12 which is in the power supply unit 10. The HDD module 20 has, although unillustrated, a module structure in which, e.g., an HDD for storing data and a circuit board are integrated, wherein the HDD and the circuit board are electrically connected. A connector 21 which is electrically connected to the circuit board is provided on the HDD module 20, and a connector 32 which is the receiver side thereof is provided on the relay substrate 30, such that the HDD module 20 can be mounted on the relay substrate 30 via the connector 21.

The relay substrate 30 is a substrate that connects the plurality of power supply units 10 and the plurality of HDD modules 20 in parallel so as to mount them thereon. The power supply units 10 and the HDD modules 20 can be connected in parallel through wiring 33 comprising patterns and through holes formed in the relay substrate 30.

Furthermore, in the relay substrate 30, a power supply boundary 34 for each group of the plurality of power supply units 10 and the plurality of HDD modules 20 are provided, and the plurality of power supply units 10 and the plurality of HDD modules 20 in each group are connected in parallel within the area divided by the power supply boundary 34 of the relay substrate 30. The power supply boundary 34 is determined such that, for example, the number of the sections of the power supply units 10 and the number of the sections of the HDD modules 20 agree. In this case, cooling of the HDD modules 20 can be uniformly performed, moreover, life lengths of the HDD modules 20 can be also uniformed. Alternatively, each section of the HDD modules 20 constitutes an FC-AL (Fibre Channel Arbitrated Loop) loop (a RAID (Redundant Array of Independent Disks) configuration in which a plurality of independent interfaces are connected to the plurality of HDD modules 20), and the power supply boundary 34 is determined such that two FC-AL loops can be controlled by one power supply unit 10. In this case, one power supply unit 10 can control two FC-AL loops by controlling two sections of the HDD modules 20.

Specifically, the power supply boundary is determined in view of the below described conditions (1) to (5).

(1) When the number of the power supply boundary is increased, the power supplies can be downsized, and maintenance work or the like is facilitated.

(2) When the power supply boundary is not created, or the number thereof is reduced, the number of the power supplies is reduced, and the cost of the entire device is reduced. (3) Cooling effects of HDD modules

As shown in FIG. 2, when the number of the sections of the HDD modules (four sections) and the number of the sections of the power supply units (four sections) are equal, the amount of the cooling wind is equal among the sections of the HDD modules. In contrast, when the number of the sections of the HDD modules and the power supply units is not equal, i.e., for example, three or two sections of the power supply units are provided for four sections of the HDD modules, since the power control unit is normally at the bottom of the power supply unit, the amount of cooling wind blown toward the HDD modules in each of the sections is not equal among them due to, for example, the inner structure of the power supply unit. Therefore, lengths of life of the HDD modules may differ.

(4) Use of the Power Supply Boundary as Physical Boundary

As shown in FIG. 2, the relay substrate is physically divided by the power supply boundary. This is enabled when it is designed such that various control signals or the like do not cross the power supply boundary. Accordingly, the device can be divided into units having a size that can be easily conveyed, for example, upon transportation of the device.

(5) FC-AL Loop

When each section of the HDD modules (in the example of FIG. 1, it includes 15 modules) constitutes an FC-AL loop, the power supply boundary is determined such that two FC-AL loops can be controlled by one power supply unit. Accordingly, one power supply unit can control two FC-AL loops.

Moreover, connectors 31 and 32 which are the receiver side of the power supply units 10 and the HDD modules 20 are provided on the relay substrate 30, and the power supply units 10 and the HDD modules 20 are mounted on the relay substrate 30 via the connectors 31 and 32, respectively. Specifically, the receiver side connectors 31 of the power supply units 10 are provided on the rear-side surface of the relay substrate 30 at a predetermined pitch, and the power supply units 10 are positioned by engaging the connectors 14 of the power supply units 10 with the connectors 31 such that they can be inserted and pulled out, therefore the power supply units are detachably mounted on the relay substrate 30 via the connectors 14 and 31. The receiver side connectors 32 of the HDD modules 20 are provided on the front-side surface of the relay substrate 30 at a predetermined pitch, and the HDD modules 20 are positioned by engaging the connectors 21 of the HDD modules 20 with the connectors 32 such that they can be inserted and pulled out, therefore the HDD modules are detachably mounted on the relay substrate 30 via the connectors 21 and 32.

In the HDD box 2 constituted as described above, the electrical connection pattern is, for example, configured as that shown in FIG. 3 in which, within the same area as that of the power supply boundary 34 of the relay substrate 30, the plurality of power supply units 10 and the plurality of HDD modules 20 in each group are connected in parallel. For example, in the example of FIG. 3, one group comprises power supply units 10a and 10b and HDD modules 20a and 20b of a first section and a second section from the top, and another group comprises power supply units 10c and 10d and HDD modules 20c and 20d of a third section and a fourth section.

Specifically, for example, the electrical connection regarding the power supply units 10c and 10d and the HDD modules 20c and 20d of the third and the fourth sections constituting one group will be described. The electrical connection regarding the power supply units 10a and 10b and the HDD modules 20a and 20b of the first and the second sections are the same.

In the power supply unit 10c of the third section, the power supply 11 in the power supply unit 10c of the third section is connected to a terminal T1 of the connector 14, and also connected to the cooling fan 12 in the power supply unit 10c through the first fuse F1 and the first diode D1 which is forwardly connected. Furthermore, a terminal T2 of the connector 14 which is connected to the power supply 11 in the power supply unit 10d of the fourth section is connected to the cooling fan 12 in the power supply unit 10c of the third section through the second fuse F2 and the second and the third diodes D2 and D3 which are forwardly connected.

Also in the power supply unit 10d of the fourth section, in the same manner as the connection in the power supply unit 10c of the third section, the power supply 11 in the power supply unit 10d of the fourth section is connected to a terminal T1 of the connector 14 thereof, and also is connected to the cooling fan 12 in the power supply unit 10d through the first fuse F1 and the first diode D1 which is forwardly connected. Furthermore, a terminal T2 of the connector 14 which is connected to the power supply 11 in the power supply unit 10c of the third section is connected to the cooling fan 12 in the power supply unit 10d of the fourth section through the second fuse F2 and the second and the third diodes D2 and D3 which are forwardly connected.

Outside the power supply units 10c and 10d of the third and the fourth sections, the power supply unit 10c of the third section and the HDD module 20c of the third section are electrically connected through the relay substrate 30. Similarly, the power supply unit 10d of the fourth section and the HDD module 20d of the fourth section are electrically connected through the relay substrate 30. Furthermore, the terminal T2 of the connector 14 of the power supply unit 10c of the third section and the terminal T1 of the connector 14 of the power supply unit 10d of the fourth section are electrically connected through the relay substrate 30. Similarly, the terminal T2 of the connector 14 of the power supply unit 10d of the fourth section and the terminal T1 of the connector 14 of the power supply unit 10c of the third section are electrically connected through the relay substrate 30.

In the above described connection pattern, the cooling fan 12 operates when power is supplied from the power supply 11 which is in the power supply unit 10 having the relevant cooling fan 12, and, in addition, power is also supplied thereto in parallel from the power supply 11 which is in another power supply unit 10 via the relay substrate 30. In each of the power supply units 10, the cooling fan is connected, in parallel, to the power supply 11 which is in the self power supply unit 10 and to the terminal T2 of the connector 14 which is the power supply path from another power supply unit 10 side, via the power control unit 13, such that power can be supplied from the power supplies 11 of the both self and another power supply units 10. Herein, although there described a mode in which the cooling fan 12 incorporates a fuse F3, there may be employed a mode in which it is externally connected.

In this case, in the present embodiment, in the power control unit 13, one diode D1 is connected between the power supply 11 and the cooling fan 12 in the self power supply unit 10, and two diodes D2 and D3 are connected between another power supply unit 10 side and the cooling fan 12. Therefore, in a normal operation, power is supplied to the cooling fan 12 from the power supply 11 which is in the self power supply unit 10 having the relevant cooling fan 12. When failure occurs in the power supply 11 which is in the self power supply unit 10, the power supply 11 which is in another power supply unit 10 different from the relevant self power supply unit 10 supplies power to the cooling fan 12 which is in the self power supply unit 10 having the relevant power supply 11.

A plurality of air communication holes (not shown) are provided in the relay substrate 30 so as to penetrate therethrough in the thickness direction, such that, when the cooling fan 12 provided in each of the power supply units 10 rotates, the airflow 40 is generated in the HDD box 2 in the direction directed from the HDD modules 20 side to the power supply units 10 side (the direction of arrows of FIG. 2), and cooling for suppressing heat generation of the HDD modules 20, the power supplies 11 of the power supply units 10, etc. is performed.

<Operation of HDD Box>

Herein, based on above described FIG. 3, operations will be described by use of, as an example, the power supply units 10c and 10d and the HDD modules 20c and 20d of the third and the fourth sections constituting one group. The operations of the power supply units 10a and 10b and the HDD modules 20a and 20b of the first and the second sections are the same.

First, in a normal operation state, when both the power supply units 10c and 10d of the third and the fourth sections supplies power to the HDD modules 20c and 20d, the disk array device operates. At the same time, in the power supply unit 10c of the third section, the power supply 11 which is in the self power supply unit 10c supplies power, through the fuse F1 and the diode D1, to the cooling fan 12 so as to actuate it, and the airflow 40 communicating in the HDD box 2 is generated, thereby carrying out heat dissipation of the power supply 11 which is in the self power supply unit 10c and the HDD module 20c which is connected via the relay substrate 30. In this case, power is not supplied to the cooling fan from the external power supply unit 10d of the fourth section which is connected thereto in parallel, since the number of the diodes is larger (D2+D3=2) than that in the self power supply unit 10c.

Similarly, also in the power supply unit 10d of the fourth section, the power supply 11 which is in the self power supply unit 10d supplies power to the cooling fan 12 so as to actuate it, and the air flow 40 communicating in the HDD box 2 is generated, thereby carrying out heat dissipation of the power supply 11 which is in the self power supply unit 10d and the HDD module 20d which is connected via the relay substrate 30. Also in this case, power is not supplied to the cooling fan from the external power supply unit 10c of the third section which is connected thereto in parallel.

Accordingly, in a normal operation state, power is supplied to the cooling fan 12 from the power supply 11 which is in the self power supply unit 10 having the relevant cooling fan 12, thereby carrying out the temperature control operation for maintaining the temperature in the HDD box 2 to equal to or less than a predetermined permissible temperature.

Herein, when either one of the power supplies 11 of the power supply units 10c and 10d of the third and the fourth sections fails, the operation of the disk array device is continued, since one power supply unit 10 fulfills the amount of operation power of the system.

Herein, if the power supply units 10c and 10d of the third and the fourth sections are not in parallel connection, the cooling fan 12 in the failed power supply unit side stops. Therefore, the cooling performance is deteriorated, and the temperature in the HDD box 2 is increased, accordingly, there is a possibility of, for example, deterioration of the reliability of the operation due to overheat of the HDD module 20.

On the other hand, in the case of the present embodiment, since the cooling fan 12 incorporated in the self power supply unit 10 can rotate by receiving power supplied from the power supply 11 of another power supply unit 10, the cooling performance can be maintained even when either one of the power supply units 10c and 10d of the third and the fourth sections fails. For example, when the power supply unit 10c of the third section fails, the fuse F1, which is connected between the power supply 11 and the cooling fan 12 in the power supply unit 10c, is disconnected due to an overcurrent. However, power is supplied to the cooling fan 12 which is in the power supply unit 10c of the third section from the power supply 11 which is in the power supply unit 10d of the fourth section through the relay substrate 30, and the fuse F2 and the diodes D2 and D3 which are in the power supply unit 10c of the third section, and the cooling fan 12 is actuated, thereby generating the airflow 40 communicating in the HDD box 2. As a result, heat dissipation of the power supply 11 which is in the power supply unit 10c of the third section and the HDD module 20c of the third section is carried out.

Therefore, when failure occurs in the power supply 11, power is supplied to the cooling fan 12 which is in the self power supply unit 10 having the relevant power supply 11 from the power supply 11 which is in another power supply unit 10 different from the relevant self power supply unit 10, therefore temperature increase in heat generation sources such as the HDD modules 20 is suppressed, and reliability of operation can be maintained.

As described above, the case of the present invention has a configuration in which, in order to supply power in parallel to the cooling fan 12 from the power supplies 11 of the power supply units 10, the power supply paths comprising the relay substrate 30 are provided in a plurality of systems, and power is supplied from the plurality of power supplies 11 to the cooling fan 12 via the power control unit 13. Therefore, even when the power supply unit 10 incorporating the cooling fan 12 fails, the cooling fan 12 continues rotating, and the reliability relating to heat generation of the device due to insufficient cooling can be ensured. In other words, as long as not all of the power supplies 11 in the same area divided by the power supply boundary 34 fails, all the cooling fans 12 in the same area divided by the power supply boundary 34 can operate, and the flow volume of the airflow 40 for cooling can be ensured.

Meanwhile, in the case of the present invention, for example, when the power supply unit 10c of the third section fails, power is supplied to the HDD module 20c of the third section also from the power supply 11 which is in the power supply unit 10d of the fourth section. Therefore, the disk array device can be operated without affecting the operation of the HDD modules 20.

<Operation of Another HDD Box>

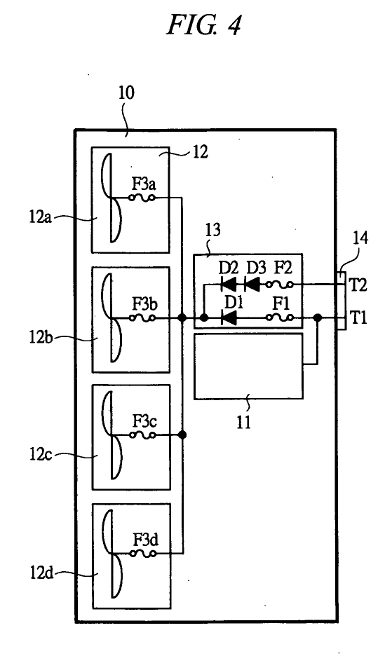

In relation to above described in FIG. 3, there described an example in which one cooling fan 12 is disposed in each of the power supply units 10. However, in practice, for example as shown in above described FIG. 1, a plurality of cooling fans 12 are disposed so as to be connected in parallel in each of the power supply units 10. As an example of this case, an example in which four cooling fans 12 are connected in parallel will be described by use of FIG. 4. FIG. 4 representatively shows only one power supply unit 10.

As shown in FIG. 4, in the power supply unit 10, the connection point of the cathode side of the first diode D1 connected to, via the first fuse F1, the power supply 11 which is in the self power supply unit 10 and the cathode side of the second and the third diodes D2 and D3 connected to, via the second fuse F2, the power supply 11 which is in another power supply unit 10, is connected to four cooling fans 12a, 12b, 12c, and 12d in parallel via fuses F3a, F3b, F3c, and F3d, respectively.

In this configuration, for example, when one cooling fan 12d which is the fourth one among the four cooling fans 12a, 12b, 12c, and 12d is shorted due to dielectric breakdown of a coil, the fuse F3d connected to the cooling fan 12d is disconnected by an overcurrent, thereby electrically shutting off the cooling fan 12d, which has undergone dielectric breakdown, from the parallel connection pattern. However, the remaining three cooling fans 12a, 12b, and 12c are actuated, so as to generate the airflow 40 communicating in the HDD box 2. As a result, heat dissipation of the power supply 11 which is in the power supply unit 10 and the HDD module 20 which is connected via the relay substrate 30 can be carried out.

Accordingly, as well as the case which employs one cooling fan 12, in a normal operation state, power is supplied to the cooling fan 12 from the power supply 11 which is in the self power supply unit 10, thereby carrying out the temperature control operation for maintaining the temperature in the HDD box 2 to equal to or less than a predetermined permissible temperature. Meanwhile, when failure occurs in the power supply 11, power is supplied from the power supply 11 which is in another power supply unit 10 to the cooling fan 12, thereby suppressing temperature increase of the heat generation sources such as the HDD modules 20 so as to maintain reliability of operation, and at the same time, the disk array device can operate without affecting the operation of the HDD modules 20.

In a connection pattern such as that shown in FIG. 4, for example, when the vicinity of the connection point of the cathode side of the first diode D1 and the cathode side of the second and the third diodes D2 and D3 is shorted, the second fuse F2 connected to the second and the third diodes D2 and D3 is disconnected due to an overcurrent, thereby preventing the influence exerted on the power supply 11 which is in another power supply unit 10 within the area divided by the power supply boundary 34.

<Effects of The Present Embodiment>

As described above, according to the disk array device of the present embodiments, the following effects can be obtained.

(1) The power supply unit 10 has the power control unit 13 which supplies power to the cooling fan 12 in a normal operation from the power supply 11 in the self power supply unit 10 having the relevant cooling fan 12, and, when failure occurs in the power supply 11, supplies power to the cooling fan 12 in the self power supply unit 10 having the relevant power supply 11 from another power supply 11 in a power supply unit 10 which is different from the relevant self power supply unit 10; therefore, power is uniformly used among the power supplies 11 in a normal operation, and shortening of the life of the power supply units 11 and deviation in heat generation thereof due to deviation of power output from the power supplies 11 can be reduced.

(2) The power supply units 10 and the HDD modules 20 are divided into groups, the power supply boundary 34 for each of the groups is provided in the relay substrate 30, and the power supply units 10 and the HDD modules 20 in each group are connected in parallel within the area divided by the power supply boundary 34 of the relay substrate 30; therefore, the power that has to be supported by one power supply 11 can be reduced, accordingly, the power supply 11 can be downsized, maintenance work is facilitated, and the area that is affected in power supply failure can be made smaller.

(3) The power supply units 10 are connected to the relay substrate 30 via the connectors 14, and the terminals for the power supply 11 and the cooling fan 12 of one power supply unit 10 are disposed in one connector 14; therefore, the power supply unit 10 can be directly connected to the relay substrate 30, and, moreover, the power supply 11 and the cooling fan 12 can be controlled by the one connector 14. Furthermore, the connector 14 has a terminal disposition with which the insertion position and insertion direction can be recognized, therefore wrong insertion can be prevented.

(4) In the power supply unit 10, the power supply 11 which is in the self power supply unit 10 is connected to the cooling fan 12 which is in the self power supply unit 10 through the first fuse F1 and the forwardly connected first diode D1, and the power supply 11 which is in another power supply unit 10 is connected to the cooling fan 12 which is in the self power supply unit 10 through the second fuse F2 and the forwardly connected second and third diodes D2 and D3; therefore, in a normal operation, the cooling fan 12 is driven by the power supplied from the power supply 11 which is in the self power supply unit 10, and, when failure occurs in the power supply 11, the cooling fan 12 can be driven by the power supplied from the power supply 11 which is in another power supply unit 10.

(5) When the power supply boundaries 34 are determined such that the number of the sections of the power supply units 10 and the number of the sections of the HDD modules 20 agree, the HDD modules 20 can be uniformly cooled, furthermore, the life lengths of the HDD modules 20 can be also uniformed.

(6) When each section of the HDD modules 20 forms an FC-AL loop, and the power supply boundary 34 is determined such that one power supply unit 10 can control two FC-AL loops, one power supply unit 10 can control two sections of the HDD modules 20, thereby controlling two FC-AL loops.

(7) In a disk array device in which an redundant configuration, addition/reduction, and replacement of the power supply units 10 can be implemented, there employed a structure in which power feeding to the cooling fans 12 for maintaining a stable device temperature is not affected by failure in the power supply system; therefore, reliability of the device operation can be improved.

Hereinabove, the invention invented by the present inventor has been described in detail with reference to embodiments. However, the present invention is not limited to the above described embodiments, and it goes without saying that various modifications can be made without departing from the scope of the invention.

### INDUSTRIAL APPLICABILITY

The present invention relates to a disk array device having power supplies, and is particularly effective when applied in temperature control techniques in a disk array device in which a redundant configuration, addition/reduction, and replacement of the power supply part can be implemented.

What is claimed is:

1. A disk array device comprising:
a plurality of power supply units each of which has a power supply and a cooling fan;
a plurality of HDD modules each of which is operated by power supplied from the power supply, and subjected to temperature control by airflow generated by the cooling fan; and
a relay substrate on which the plurality of power supply units and the plurality of HDD modules are connected in parallel and mounted; wherein
each of the plurality of power supply units has a power control unit for supplying power to the cooling fan in a normal operation from the power supply which is in self power supply unit having the relevant cooling fan, and, when failure occurs in the power supply, supplying power to the cooling fan which is in the self power supply unit having the relevant power supply from another power supply which is in the power supply unit different from the relevant self power supply unit.

2. The disk array device according to claim 1, wherein
the plurality of power supply units and the plurality of HDD modules are divided into groups,
a power supply boundary for each of the groups is provided in the relay substrate, and
the plurality of power supply units and the plurality of HDD modules in each of the groups are connected in parallel within an area divided by the power supply boundary of the relay substrate.

3. The disk array device according to claim 1, wherein
each of the plurality of power supply units is connected to the relay substrate via a connector, and
terminals connected to the power supply and the cooling fan of one of the power supply units are disposed in one the connector.

4. The disk array device according to claim 3, wherein
the connector has a terminal disposition which enables recognition of an insertion position and an insertion direction.

5. The disk array device according to claim 1, wherein
the power control unit has first and second current limiting devices and first to third backflow prevention devices,
the power supply which is in the self power supply unit is connected to the cooling fan in the self power supply unit through the first current limiting device and the first backflow prevention device which is forwardly connected, and
the power supply which is in the another power supply unit is connected to the cooling fan in the self power supply unit through the second current limiting device and the second and the third backflow prevention devices which are forwardly connected.

6. The disk array device according to claim 2, wherein
each of the plurality of power supply units and the plurality of HDD modules comprises a plurality of sections, and
the power supply boundary is determined such that number of the sections of the power supply units and number of the sections of the HDD modules agree.

7. The disk array device according to claim 2, wherein
each of the plurality of power supply units and the plurality of HDD modules comprises a plurality of sections,
each of the sections of the HDD modules has a RAID configuration in which a plurality of independent interfaces are connected to a plurality of the HDD modules, and
the power supply boundary is determined such that one of the power supply units can control two of the RAID configurations.
